(19) United States
(12) Patent Application Publication
(10) Pub. No.: US 2025/0298518 A1
(43) Pub. Date: Sep. 25, 2025

(54) HIGHER-LEVEL-TO-LOWER-LEVEL CELL BLOCK TRANSFER BASED READ COUNT

(71) Applicant: Micron Technology, Inc., Boise, ID (US)

(72) Inventors: Arghyadeep Bandyopadhyay, Haldia (IN); Abhishek Shetty, Bangaluru (IN); Palash Arora, Narmadapuram (IN)

(21) Appl. No.: 19/085,704

(22) Filed: Mar. 20, 2025

Related U.S. Application Data
(60) Provisional application No. 63/568,253, filed on Mar. 21, 2024.

(51) Int. Cl. G06F 3/06

(52) U.S. Cl. CPC G06F 3/0619; G06F 3/064; G06F 3/0653; G06F 3/0679

(57) ABSTRACT

Various embodiments provide for performing a higher-level-to-lower-level cell block transfer (e.g., quad-level cell (QLC)-to-triple-level cell (TLC) block transfer) on a higher-level cell block (e.g., a QLC block) of a memory device based on a read count of the higher-level cell block, where the memory device can be part of a memory system, such as a memory sub-system.

### PRIORITY APPLICATION

This application claims the benefit of priority to U.S. Provisional Application Ser. No. 63/568,253, filed Mar. 21, 2024, which is incorporated herein by reference in its entirety.

### TECHNICAL FIELD

Example embodiments of the disclosure relate generally to memory devices and, more specifically, to performing a higher-level-to-lower-level cell block transfer on a memory device based on a read count of the higher-level cell block, where the memory device can be part of a memory system, such as a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIGS. 2 and 3 illustrate flow diagrams of example methods for performing a higher-level-to-lower-level cell block transfer on a memory device based on a read count of the higher-level cell block, in accordance with some embodiments of the present disclosure.

FIG. 4 is a block diagram of an example computer system in which embodiments of the present disclosure may operate.

### DETAILED DESCRIPTION

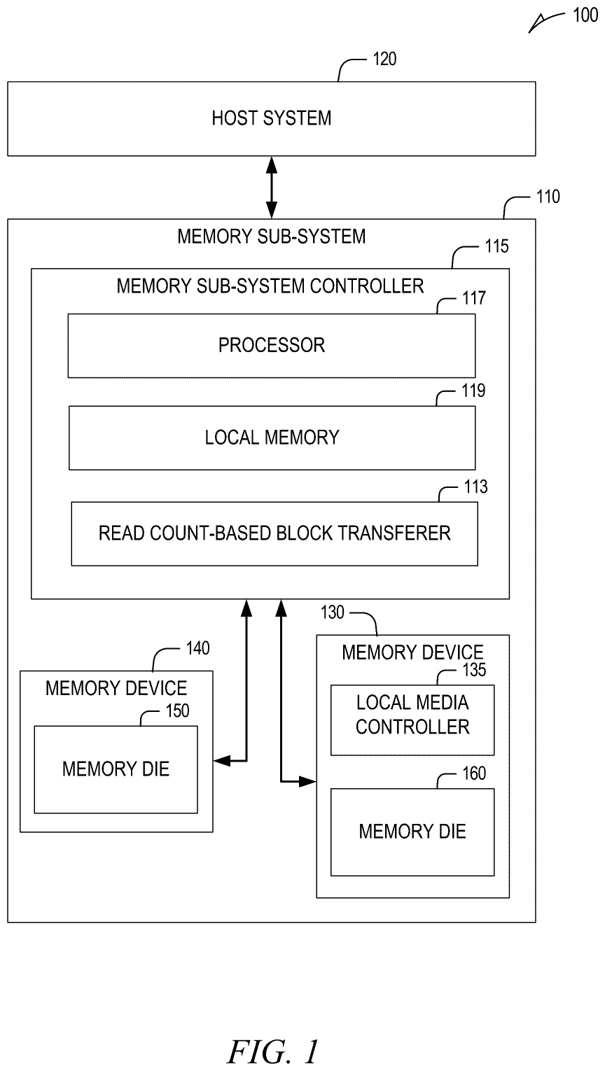

Aspects of the present disclosure are directed to performing a higher-level-to-lower-level cell block transfer (e.g., quad-level cell (QLC)-to-triple-level cell (TLC) block transfer) on a memory device (e.g., NAND-type memory device) based on a read count of the higher-level cell block, where the memory device can be part of a memory system, such as a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write commands, read commands) to the memory sub-system, such as to store data on a memory device at the memory sub-system, read data from the memory device on the memory sub-system, or write/read constructs with respect to a memory device on the memory sub-system. The data to be read or written, as specified by a host request (e.g., data access request or command request), is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error-correcting code (ECC) codeword, parity code), data version (e.g., used to distinguish age of data written), valid bitmap (which LBAs or logical transfer units contain valid data), and so forth.

The memory sub-system can initiate media management operations, such as a write operation on host data that is stored on a memory device or a scan (e.g., media scan) of one or more blocks of a memory device. For example, firmware of the memory sub-system can re-write previously written host data from a location of a memory device to a new location as part of garbage collection management operations. The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as an L2P table), data from logging, scratch pad data, and so forth).

A memory device can be a non-volatile memory device. A non-volatile memory device is a package of one or more die. Each die can comprise one or more planes. For some types of non-volatile memory devices (e.g., NOT-AND (NAND)-type devices), each plane comprises a set of physical blocks. For some memory devices, blocks are the smallest area that can be erased. Each block comprises a set of pages. Each page comprises a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package.

Generally, writing data to such memory devices involves programming (by way of a program operation) the memory devices at the page level of a block, and erasing data from such memory devices involves erasing the memory devices at the block level (e.g., page level erasure of data is not possible). Certain memory devices, such as NAND-type memory devices, comprise one or more blocks, (e.g., multiple blocks) with each of those blocks comprising multiple pages, where each page comprises a subset of memory cells of the block, and where a single wordline of a block (which connects a group of memory cells of the block together) defines one or more pages of a block (depending on the type of memory cell). Depending on the embodiment, different blocks can comprise different types of memory cells. For instance, a block (a single-level cell (SLC) block) can comprise multiple SLCs, a block (a multi-level cell (MLC) block) can comprise multiple MLCs, a block (a triple-level cell (TLC) block) can comprise multiple TLCs, a block (a quad-level cell (QLC) block) can comprise QLCs, and a block (a penta-level cell (PLC) block) can comprise PLCs. Other blocks comprising other types of memory cells (e.g., higher-level memory cells, having higher bit storage-per-cell) are also possible. For some NAND-type memory devices, a plurality of memory cells that implement a single higher-level cell block (e.g., QLCs implementing a QLC block) can be erased in a lower-level cell mode (e.g., erased in TLC, MLC, or SLC mode) such that the plurality of erased memory cells can be reused as a single lower-level cell block (e.g., reused as a TLC, MLC, or SLC block, respectively).

Each worldline (of a block) can define one or more pages depending on the type of memory cells (of the block) connected to the wordline. For example, for an SLC block, a single wordline can define a single page. For an MLC block, a single wordline can define two pages—a lower page (LP) and an upper page (UP). For a TLC block, a single wordline can define three pages—a lower page (LP), an upper page (UP), and an extra page (XP). For a QLC block, a single wordline can define four pages—a lower page (LP), an upper page (UP), an extra page (XP), and a top page (TP) page. As used herein, a page of LP page type can be referred to as a “LP page,” a page of UP page type can be referred to as a “UP page,” a page of XP page type can be referred to as a “XP page,” and a page of TP page type can be referred to as a “TP page.” Each page type can represent a different level of a cell (e.g., QLC can have a first level for LPs, a second level for UPs, a third level for XPs, and a fourth level for TPs). To write data to a given page, the given page is programmed according to a page programming algorithm (e.g., that causes one or more voltage pulses or pulses to memory cells of a block based on the memory).

Today, data workloads (e.g., generated by a host system) that have a large number of reads are expected to take longer on QLC blocks as compared to TLC blocks. This is because read times for higher-level cell blocks, such as QLC blocks, tend to be higher than the read time of lower-level cell blocks, such as TLC blocks. For instance, a typical page read time (tR) for QLC blocks can be 74 μs, while the read time (tR) for TLC blocks can be 39 μs. As a result, reading from a TLC block is usually faster than reading from a QLC block. Additionally, NAND-type memory devices comprising QLC blocks (hereafter, QLC NAND-type memory devices) tend to have lower read window budgets compared to NAND-type memory devices comprising TLC blocks (hereafter, TLC NAND-type memory devices). This can result in more pronounced effects on the raw bit error rate (RBER) of QLC NAND-type memory devices due to physical factors, such as charge loss, read disturb, and the like.

Various embodiments presented herein provide can cure these and other deficiencies of performing a large number of reads on a higher-level cell block (e.g., a QLC block) of a memory device. In particular, various embodiments presented herein provide for performing a higher-level-to-lower-level cell block transfer on a higher-level cell block of a memory device (e.g., NAND-type memory device) based on a read count (e.g., total read count) of the higher-level cell block, where the memory device can be part of a memory system, such as a memory sub-system. For example, if high number of reads (e.g., requested by a host system) are directed to a certain QLC block, an embodiment described herein can reduce the read times for data stored on the QLC block data by transferring the data from the QLC block to one or more TLC blocks and performing one or more subsequent reads on the one or more TLC blocks (e.g., blocks in TLC OTF mode) to read the data. The decision to transfer can be based on one or more trigger conditions. A given trigger condition can check whether one or more certain attributes, such as total read count for the block, exceed a predetermined threshold. Another example trigger condition can comprise a trigger threshold based on one or more raw bit error rate (RBER) values. Such a RBER-related trigger condition can provide the added benefit of reducing RBER and improving data retention by utilizing better tolerances of blocks (e.g., TLC blocks) to charge loss. For various embodiments, a lower-level cell block of memory device that receives transferred data from a higher-level cell block is another higher-level cell block that has been prepared for use in the lower-level cell mode (e.g., erased in the lower-level cell mode). For instance, where the memory device is a QLC NAND-type memory devices, the higher-level cell blocks of the memory device operating in QLC mode as QLC blocks, and the lower-level cell blocks of the memory device that would otherwise operate in QLC mode but have been repurposed or erased (e.g., erased in TLC mode) to operate in TLC mode (e.g., TLC on-the-fly mode) as TLC blocks.

Depending on the embodiment, determining (e.g., checking) whether to transfer an individual higher-level cell block (e.g., QLC block) to one or more lower-cell level blocks (e.g., TLC block) can occur periodically (e.g., as part of a background operation), or can occur each time a read of the individual higher-level cell block is performed (e.g., performed in response to a read request from a host system). Additionally, data is transferred from a (source) higher-level cell block to a (destination) lower-level cell block, the source, the source higher-level cell block can be released (e.g., back in in the higher-level cell block pool for data reuse) or retained based on higher-level cell block availability; the release/retention of higher-level cell blocks can be initiated by a folding write service. For example, an embodiment can defer releasing a source higher-level cell block after transfer to save time if there is sufficient higher-level cell blocks available for use. The block stripes of the lower-level cell block pool (e.g., TLC pool) can be treated as less full (e.g., 75% or less full) compared to the block stripes of the higher-level cell block pool (e.g., QLC pool). Further, additional weights can be added to PVTC (valid translation unit counts) to prevent block stripes from being picked immediately as source candidate for folding.

For some embodiments, a read count maintained for an individual higher-level cell block (e.g., a QLC block) is a periodic read count, which is tracked within a fixed time interval (e.g., 24 hours) and reset after that (e.g., reset to an initial value after a predetermined period of time). According to some embodiments, a threshold value (e.g., upper threshold value for read count, lower threshold value for read count, or both) is determined based on a maximum number of possible reads (e.g., in a fixed time interval) for a block of a memory device operating in the higher-level cell mode. For example, an upper threshold value can be determined based on a maximum number of possible reads for a TLC block within a 24 hour period, and a lower threshold value can be determined based on midpoint value between a maximum number of possible reads for a QLC block within a 24 hour period and the maximum number of possible reads for the TLC block within a 24 hour period. Additionally, for some embodiment, a RBER threshold value can be set to a value similar to one used by a scan algorithm (e.g., such as a read disturb scan check for RBER threshold for making folding decisions).

Various embodiments can handle multiple higher-level cell blocks (e.g., QLC blocks) on a memory device (e.g., a NAND-type memory device) that have large read counts and transfer their respective data to lower-level cells (e.g., TLC blocks) on the memory device. This can lead to an overall improvement in the read input/output performance (IOP) for a read-intensive workload (e.g., involving a larger number of read operations compared to write operations), which in turn can improve the performance of workloads generated by a software application operating on a host system. Some embodiments can reduce read disturb on a memory device, as higher-level cell blocks (e.g., QLC blocks) have more read disturb compared to lower-level cell (e.g., TLC blocks). Additionally, some embodiment can improve data retention given that read levels for lower-level cell blocks (e.g., TLC blocks) typically show lower degradation due to charge loss compared to read levels of higher-level cell blocks (e.g., QLC blocks). Additionally, some embodiments can avoid or reduce read performance impact (e.g., due to data movement) by ensuring that higher-level cell-to-lower-level cell block transfers as described herein are performed at a slower rate (e.g., slower rate compared to typical relocation or folding operations).

During operation, as a memory device fills up with stored data, data stored on one or more lower-level cell blocks (e.g., TLC blocks) can be moved back from the one or more lower-level cell blocks to one or more higher-level cell blocks (e.g., QLC blocks), and the one or more lower-level cell blocks can be repurposed or erased (in the higher-level cell mode) for use as one or more higher-level cell blocks, which can be added to a pool of higher-level cell blocks available for use (e.g., data storage). Eventually, the size of the pool of available lower-level cell block (e.g., TLC block) can shrink/diminish as data moves back from lower-level cell blocks to higher-level cell blocks.

For facilitate higher-level cell-to-lower block transfers, some embodiments maintain a lower-level cell block band area (e.g., TLC data band area) or pool that is dynamically-sized and that comprises a plurality of lower-level cell blocks (e.g., TLC blocks). An embodiment can vary the size of the lower-level cell block band area/pool based on a linear relationship. For instance, the linear relationship where the lower-level cell block band area/pool decreases as the available capacity of the memory device decreases (e.g., the linear relationship where the fill percentage of the memory device has a negative slope with respect to the size of the lower-level cell block band area/pool). By using a dynamically-sized lower-level cell block band area or pool (e.g., instead of initializing all the data band blocks as TLC mode at time 0) can help in reducing write amplification while not compromising write performance of the memory device. If all the blocks of a QLC NAND-type memory device were initially in TLC mode, this could result in 75% of maximum drive capacity being utilized, and as the drive fill percent approaches 75%, it would have led to a marked increase in write amplification due to folding (e.g., folding from TLC to QLC area would involve choosing 4 TLC source blocks and transferring their data to 3 QLC destination blocks, thereby freeing up 1 block and implying a write amplification of 4×).

As used herein, raw bit error rate (RBER) can refer to a fraction of bits in a set of cells (e.g., in a page or a block of a NAND-type memory device) that contains incorrect data before an error correction technique (such as error-correction codes (ECC)) is applied to the set of cells.

While some examples described herein involve triple-level cells (TLCs) and quad-level cells (QLCs), in various other embodiments, similar techniques can be implemented with cells storing other numbers of bits per cell.

Disclosed herein are some examples of performing a higher-level-to-lower-level cell block transfer on a memory device (e.g., a NAND-type memory device of a memory system) based on a read count of the higher-level cell block, as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130 can include one or more arrays of memory cells. One type of memory cell, for example, SLCs, can store one bit per cell. Other types of memory cells, such as MLCs, TLCs, QLCs, and penta-level cells (PLCs), can store multiple or fractional bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as an MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative- or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands, requests, or operations from the host system 120 and can convert the commands, requests, or operations into instructions or appropriate commands to achieve the desired access to the memory devices 130 and/or the memory device 140. The memory sub-system controller 115 can be responsible for other operations such as wear leveling operations, garbage collection operations, error detection and ECC operations, encryption operations, caching operations, and address translations between a logical address (e.g., LBA, namespace) and a physical memory address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 as well as convert responses associated with the memory devices 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

Each of the memory devices 130, 140 include a memory die 150, 160. For some embodiments, each of the memory devices 130, 140 represents a memory device that comprises a printed circuit board, upon which its respective memory die 150, 160 is solder mounted.

The memory sub-system controller 115 includes a read count-based block transferer 113 that enables or facilitates the memory sub-system controller 115 to perform a higher-level-to-lower-level cell block transfer (e.g., QLC-to-TLC block transfer) on a higher-level cell block of a memory device (e.g., 130, 140) based on a read count of the higher-level cell block as described herein. Some or all of the read count-based block transferer 113 is included by the local media controller 135 to perform a higher-level-to-lower-level cell block transfer on a higher-level cell block of a memory device (e.g., 130, 140) based on a read count of the higher-level cell block as described herein.

According to some embodiments, the read count-based block transferer 113 causes the memory sub-system controller 115 to choose one or more higher-level cell blocks (e.g., QLC blocks) for transfer to lower-level cell blocks (e.g., TLC blocks) based on their respective read counts, which can serve as a primary factor for selection, or based on satisfaction of at least one trigger condition (e.g., condition based on observed RBERs of those higher-level cell blocks) as a secondary factor. For some embodiments, the read count-based block transferer 113 causes the memory sub-system controller 115 to maintain two thresholds relating to read count: a lower threshold value; and an upper threshold value. If the read count of an individual higher-level cell block (e.g., QLC block) is above the upper threshold value, the memory sub-system controller 115 (based on the read count-based block transferer 113) can mark the individual higher-level cell block as a candidate for data transfer to one or more lower-level cell blocks (e.g., regardless of the individual higher-level cell block's RBER value). If, however, the read count of the individual higher-level cell block lies between the lower and upper threshold values, the memory sub-system controller 115 can perform an additional check based on another trigger condition, such as one relating to the RBER of the individual higher-level cell block. For instance, the memory sub-system controller 115 (based on the read count-based block transferer 113) can check the RBER of the individual higher-level cell block against a RBER threshold value and, if the RBER value is larger than the RBER threshold value, the memory sub-system controller 115 can mark the individual higher-level cell block for data transfer to one or more lower-level cell blocks. For some embodiments, data from one or more marked higher-level cell blocks are eventually transferred to one or more lower-level cell blocks, such as by way of performing a folding operation on the one or more marked higher-level cell blocks.

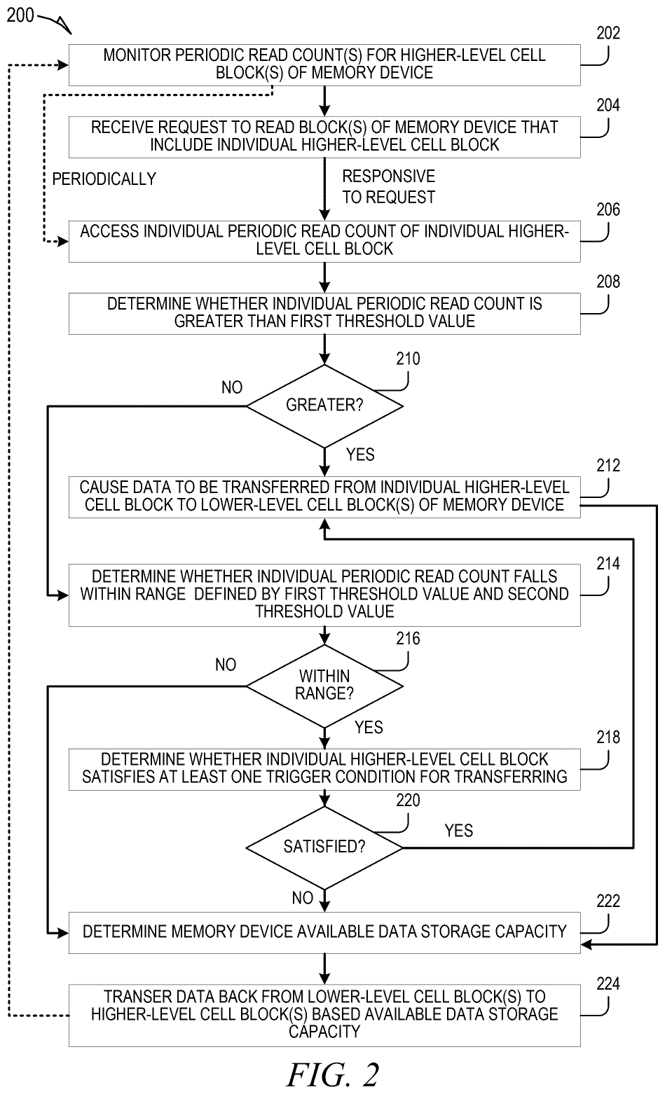

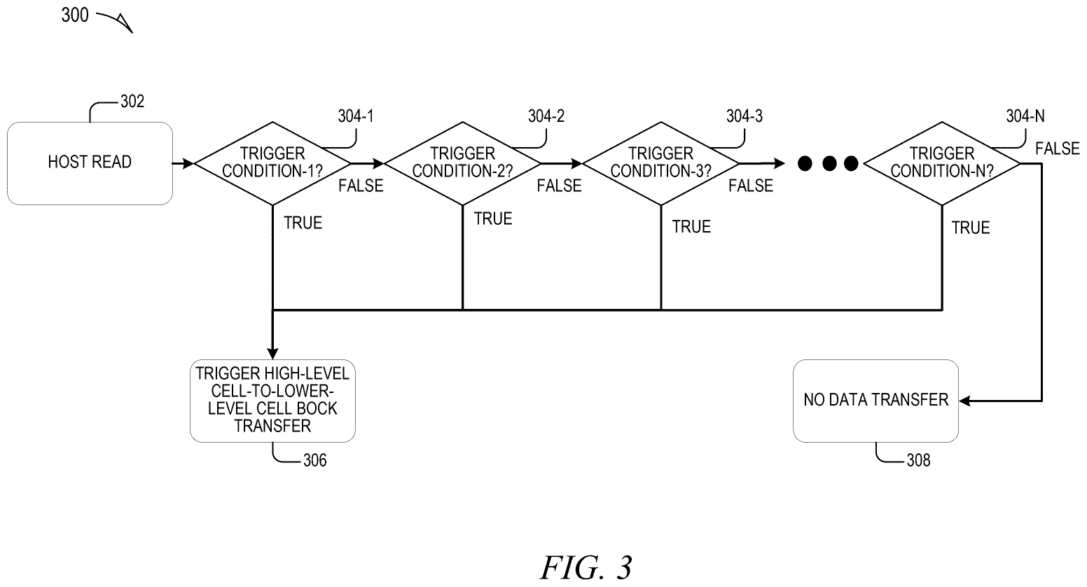

FIGS. 2 and 3 illustrate flow diagrams of example methods 200, 300 for performing a higher-level-to-lower-level cell block transfer on a higher-level cell block of a memory device based on a read count of the higher-level cell block, in accordance with some embodiments of the present disclosure. Any of methods 200, 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, one or more of methods 200, 300 is performed by the memory sub-system controller 115 of FIG. 1 based on the read count-based block transferer 113. Additionally, or alternatively, for some embodiments, one or more of methods 200, 300 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

Referring now to method 200 of FIG. 2, at operation 202, a processing device (e.g., the processor 117 of the memory sub-system controller 115, or the local media controller 135) monitors a set of periodic read counts for a set of higher-level cell blocks of the memory device. For example, each higher-level cell block can be a QLC block. For some embodiments, each periodic read count of the set of periodic read counts is reset to an initial value (e.g., value of 0) after a predetermined period of time. For instance, where a time interval of the of periodic read count is 24 hours, each periodic read count can be reset to 0 at (or soon after) 24 hours has expired. The processing device can maintain (e.g., store) the set of periodic read counts in local memory (e.g., 119) operatively coupled to the processing device, and can increment (e.g., by a value of 1) a read count of a select higher-level cell block for each read operation performed on the select higher-level cell block.

At operation 204, the processing device (e.g., the processor 117) receives (e.g., from a host system, such as the host system 120) a request to read (e.g., to perform a read operation) on a set of blocks of the memory device. In response to receiving the request, the processing device performs operation 206 for an individual higher-level cell block of the set of higher-level cell blocks. For some embodiments, operation 206, and one or more of operations that follow thereafter, are performed for each individual higher-level cell block of the set of higher-level cell blocks. Alternatively, operation 206 (and one or more of operations that follow thereafter) can be performed periodically without need for a request to perform a read operation that involves the individual higher-level cell block. For instance, operation 206 can be performed periodically based on the predetermined period of time associated with the set of periodic read counts. For example, if the predetermined period of time for resetting the set of periodic read counts is 24 hours, operation 206 can performed one or more times before that the predetermined period of time expires and the set of periodic read counts is reset.

During operation 206, the processing device (e.g., the processor 117) accesses, from the set of periodic read counts, an individual periodic read count of the individual higher-level cell block. After operation 206, at operation 208, the processing device (e.g., the processor 117) determines (e.g., checks) whether the individual periodic read count is greater than a first threshold value. This first threshold value can represent an upper threshold value for read counts. The first threshold value can be determined based on a maximum number of possible reads (e.g., in a fixed time interval) for a block of a memory device operating in the lower-level cell mode or the higher-level cell mode. For example, the first threshold value can be determined based on a maximum number of possible reads for a lower-level cell block within a time interval period (e.g., 24 hour period). At operation 210, in response to the processing device determining that the individual periodic read count is greater than a first threshold value, method 200 proceeds to operation 212, otherwise method 200 proceeds to operation 214.

At operation 212, the processing device (e.g., the processor 117) causes data to be transferred from the individual higher-level cell block to one or more lower-level cell blocks (e.g., TLC blocks) of the memory device. For example, where the individual higher-level cell block is a QLC block, each lower-level cell block can be a TLC block, an MLC block, or a SLC block. The one or more lower-level cell blocks can be selected from a pool of available lower-level cell blocks (e.g., TLC blocks) on the memory device. After the transfer, requests to read the transferred data can be provided by the one or more lower-level cell blocks. For some embodiments, operation 212 comprises performing a folding operation on the individual higher-level cell block to cause data to be transferred from the individual higher-level cell block to the one or more lower-level cell blocks. Alternatively, for some embodiments, operation 212 comprises marking the individual higher-level cell block as a candidate for higher-level cell-to-lower-level cell block data transfer. Eventually (e.g., periodically), a folding operation can be performed on a set of marked higher-level cell blocks, which includes the marked individual higher-level cell block, where the folding operation causes data of each select higher-level cell block in the set of marked higher-level cell blocks to be transferred to a set of select lower-level cell blocks of the memory device. Depending on the embodiment, the individual higher-level cell block can be released (e.g., to a pool of available higher-level cell blocks) for reuse after data has been copied from the individual higher-level cell block to the one or more lower-level cell blocks. For facilitate higher-level cell-to-lower block transfers, the processing device can maintain a lower-level cell block band area or pool that is dynamically-sized and that comprises a plurality of lower-level cell blocks available for use during a transfer. After operation 212, method 200 can proceed to operation 222.

At operation 214, the processing device (e.g., the processor 117) determines whether the individual periodic read count falls within a range of read count values defined by the first threshold value and the second threshold value. For example, the processing device can determine whether the individual periodic read count is less than or equal to the first threshold value and the individual periodic read count is greater than a second threshold value. This second threshold value can represent a lower threshold value for read counts. The first threshold value and the second threshold value can be determined based on a maximum number of possible reads (e.g., in a fixed time interval) for a block of a memory device operating in the lower-level cell mode or the higher-level cell mode. For example, the first threshold value can be determined based on a maximum number of possible reads for a lower-level cell block (e.g., TLC block) within a time interval period (e.g., 24 hour period), and a lower threshold value can be determined based on midpoint value between a maximum number of possible reads for a higher-level cell block (e.g., QLC block) within the time interval period (e.g., 24 hour period) and the maximum number of possible reads for the lower-level cell block (e.g., TLC block) within the time interval period (e.g., 24 hour period). At operation 216, in response to the processing device determining that the individual periodic read count falls within the range defined by the first threshold value and the second threshold value, method 200 proceeds to operation 218, otherwise method 200 proceeds to operation 222 with no transfer being triggered for the individual higher-level cell block.

During operation 218, the processing device (e.g., the processor 117) determines whether the individual higher-level cell block satisfies at least one trigger condition for transferring the individual higher-level cell block to the one or more lower-level cell blocks. The at least one trigger condition can relate to a raw error bit rate (RBER) of the individual higher-level cell block. For example, the at least one trigger condition is satisfied when the RBER of the individual higher-level cell block is greater than a RBER threshold value. At operation 220, in response to determining that the individual higher-level cell block satisfies the at least one trigger condition, method 200 proceeds to operation 212, otherwise method 200 proceeds to operation 222 with transfer being triggered for the individual higher-level cell block. For some embodiments, the at least one trigger condition comprises a series of trigger conditions, and determining satisfaction of the at least one trigger condition comprises sequentially determining whether each individual trigger condition is satisfied until at least one is satisfied (and triggers the transfer) or until it is determined that none of the trigger conditions are satisfied (which would lead to no method 200 proceeding to operation 222 with no transfer being triggered). Where operation operations 208, 210 represent evaluation of a primary trigger condition for triggering data transfer from the individual higher-level cell block to one or more lower-level cell blocks, operations 218, 220 represent evaluation of one or more secondary trigger conditions for triggering data transfer from the individual higher-level cell block to one or more lower-level cell blocks.

By operations 222, 224, the processing device (e.g., the processor 117) can manage availability of lower-level cell blocks on the memory device for higher-level cell-to-lower-level cell block transfers, can manage availability of higher-level cell blocks as the available data storage capacity of the memory device decreases. For some embodiments, operations 222, 224 are performed such that availability of lower-level cell blocks and higher-level cell blocks is balanced. At operation 222, the processing device determines available data storage capacity of the memory device and, at operation 224, the processing device transfers data back from the one or more lower-level cell blocks to one or more higher-level cell blocks based on the available data storage capacity. The processing device can vary the size of the lower-level cell block band area/pool based on a linear relationship. For instance, the linear relationship where the lower-level cell block band area/pool decreases as the available capacity of the memory device decreases. As described herein, using a dynamically-sized lower-level cell block band area or pool can help in reducing write amplification while not compromising write performance of the memory device. Operations 222, 224 can be performed periodically, and operations 222, 224 can represent operations performed in as background operations. After operation 224, method 200 can return to operation 202, where the set of periodic read counts continues to be monitored and accessed for one or more higher-level cell blocks to determine whether to trigger a higher-level cell-to-lower-level cell block transfer.

Referring now to method 300 of FIG. 3, method 300 represents an example implementation of method 200. In FIG. 3, trigger conditions on the left have a higher priority in triggering a higher-level cell-to-lower-level cell block transfer than those on the left. Once a trigger condition on the left evaluates to false (e.g., not satisfied), method 300 moves to the right and evaluates the next trigger condition to the right. This continues from trigger condition 1 through trigger condition N, until either one of the trigger conditions is true (e.g., satisfied), or the last trigger condition N is false (e.g., not satisfied), which results in no data transfer from a higher-level cell-to-lower-level cell block taking place.

As shown, at operation 302, a memory system performs a host read on an individual high-level cell block, which can be a QLC block as described herein. At operation 304-1, the memory system determines whether trigger condition 1 is true (e.g., satisfied). Trigger condition 1 can represent performing operations 208, 210 of method 200. If trigger condition 1 is true (e.g., satisfied), method 300 proceeds to operation 306, where the memory system triggers a higher-level cell-to-lower-level cell block transfer to be performed on the individual high-level cell block. However, if trigger condition 1 is false (e.g., not satisfied), method 300 proceeds to operation 304-2, where the memory system determines whether trigger condition 2 is true (e.g., satisfied). Trigger condition 2 can represent performing operations 214, 216, 218, 220 of method 200. If trigger condition 2 is true (e.g., satisfied), method 300 proceeds to operation 306, where the memory system triggers a higher-level cell-to-lower-level cell block transfer to be performed on the individual high-level cell block. However, if trigger condition 1 is false (e.g., not satisfied), method 300 proceeds to operation 304-2, where the memory system determines whether trigger condition 3 is true (e.g., satisfied). As noted, method 300 repeats itself in this way for trigger conditions 3 through N until either one of the trigger conditions is true (e.g., satisfied) or trigger condition N is false (e.g., not satisfied), and method 300 proceeds to operation 308, where the memory system determines to perform no high-level cell-to-low-level cell block transfer.

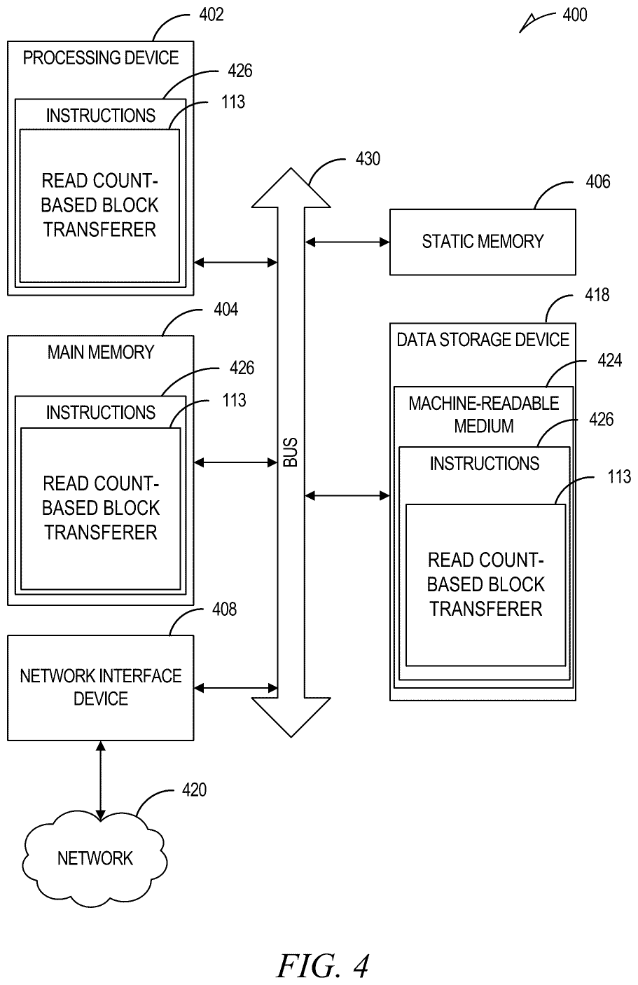

FIG. 4 illustrates an example machine in the form of a computer system 400 within which a set of instructions can be executed for causing the machine to perform any one or more of the methodologies discussed herein. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., ROM, flash memory, DRAM such as SDRAM or Rambus DRAM (RDRAM), etc.), a static memory 406 (e.g., flash memory, static random access memory (SRAM), etc.), and a data storage device 418, which communicate with each other via a bus 430.

The processing device 402 represents one or more general-purpose processing devices such as a microprocessor, a central processing unit, or the like. More particularly, the processing device 402 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 402 can also be one or more special-purpose processing devices such as an application-specific integrated circuit (ASIC), a field programmable gate array (FPGA), a digital signal processor (DSP), a network processor, or the like. The processing device 402 is configured to execute instructions 426 for performing the operations and steps discussed herein. The computer system 400 can further include a network interface device 408 to communicate over a network 420.

The data storage device 418 can include a machine-readable storage medium 424 (also known as a computer-readable medium) on which is stored one or more sets of instructions 426 or software embodying any one or more of the methodologies or functions described herein. For some embodiments, the machine-readable storage medium 424 is a non-transitory machine-readable storage medium. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage device 418, and/or main memory 404 can correspond to the memory sub-system 110 of FIG. 1.

In one embodiment, the instructions 426 include instructions to implement functionality corresponding to performing a higher-level-to-lower-level cell block transfer on a memory device as described herein (e.g., the read count-based block transferer 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory device; and a processing device, operatively coupled to the memory device, configured to perform operations comprising: monitoring a set of periodic read counts for a set of higher-level cell blocks of the memory device, each periodic read count of the set of periodic read counts being reset to an initial value after a predetermined period of time; and for an individual higher-level cell block of the set of higher-level cell blocks: accessing, from the set of periodic read counts, an individual periodic read count of the individual higher-level cell block; determining whether the individual periodic read count is greater than a threshold value; and in response to determining that the individual periodic read count is greater than the threshold value, causing data to be transferred from the individual higher-level cell block to one or more lower-level cell blocks of the memory device.

In Example 2, the subject matter of Example 1 includes, wherein the causing of the data to be transferred from the individual higher-level cell block to the one or more lower-level cell blocks of the memory device comprises: performing a folding operation on the individual higher-level cell block to cause data to be transferred from the individual higher-level cell block to the one or more lower-level cell blocks.

In Example 3, the subject matter of Examples 1-2 includes, wherein the causing of the data to be transferred from the individual higher-level cell block to the one or more lower-level cell blocks comprises: marking the individual higher-level cell block as a candidate for higher-level cell-to-lower-level cell block data transfer.

In Example 4, the subject matter of Example 3 includes, wherein the individual higher-level cell block is part of a set of marked higher-level cell blocks that are marked as candidates for higher-level cell-to-lower-level cell block data transfer, and wherein the operations comprise: performing a folding operation on the set of marked higher-level cell blocks, the folding operation causing data of each select higher-level cell block in the set of marked higher-level cell blocks to be transferred to a set of select lower-level cell blocks of the memory device.

In Example 5, the subject matter of Examples 1-4 includes, wherein each higher-level cell block is a quad-level cell (QLC) block.

In Example 6, the subject matter of Examples 2-5 includes, wherein each lower-level cell block is a triple-level cell (TLC) block.

In Example 7, the subject matter of Examples 1-6 includes, wherein the threshold value is a first threshold value, and wherein the operations comprise: in response to determining that the individual periodic read count is not greater than the first threshold value: determining whether the individual periodic read count is less than or equal to the first threshold value and the individual periodic read count is greater than a second threshold value; and in response to determining that the individual periodic read count is less than or equal to the first threshold value and that the individual periodic read count greater than a second threshold value: determining whether the individual higher-level cell block satisfies at least one trigger condition for transferring the individual higher-level cell block to the one or more lower-level cell blocks; and in response to determining that the individual higher-level cell block satisfies the at least one trigger condition, causing data to be transferred from the individual higher-level cell block to one or more lower-level cell blocks of the memory device.

In Example 8, the subject matter of Example 7 includes, wherein the at least one trigger condition relates to a raw error bit rate (RBER) of the individual higher-level cell block.

In Example 9, the subject matter of Example 8 includes, wherein the at least one trigger condition is satisfied when the RBER of the individual higher-level cell block is greater than a RBER threshold value.

In Example 10, the subject matter of Examples 1-9 includes, wherein the causing of the data to be transferred from the individual higher-level cell block to one or more lower-level cell blocks of the memory device comprises: releasing the individual higher-level cell block for reuse after data has been copied from the individual higher-level cell block to the one or more lower-level cell blocks.

In Example 11, the subject matter of Examples 1-10 includes, wherein the operations comprise: receiving, from a host system, a request to read a set of blocks of the memory device, the set of blocks including the individual higher-level cell block, the accessing of the individual periodic read count being performed in response to the request.

In Example 12, the subject matter of Examples 1-11 includes, wherein the accessing of the individual periodic read count is performed periodically based on the predetermined period of time.

In Example 13, the subject matter of Examples 1-12 includes, wherein the operations comprise: determining available data storage capacity of the memory device; and transferring data back from the one or more lower-level cell blocks to one or more higher-level cell blocks based on the available data storage capacity.

Example 14 is at least one machine-readable medium including instructions that, when executed by a processing device of a memory sub-system, cause the processing device to perform operations to implement of any of Examples 1-13.

Example 15 is a method to implement of any of Examples 1-13.

Example 16 is at least one non-transitory machine-readable storage medium comprising instructions that, when executed by a processing device of a memory sub-system, cause the processing device to perform operations comprising: accessing an individual periodic read count of an individual higher-level cell block of a memory device of the memory sub-system, the individual periodic read count being reset to an initial value after a predetermined period of time; determining whether the individual periodic read count is greater than a threshold value; and in response to determining that the individual periodic read count is greater than the threshold value, causing data to be transferred from the individual higher-level cell block to one or more lower-level cell blocks of the memory device.

In Example 17, the subject matter of Example 14 includes, wherein the operations are performed periodically based on the predetermined period of time.

In Example 18, the subject matter of Examples 14-15 includes, wherein the causing of the data to be transferred from the individual higher-level cell block to the one or more lower-level cell blocks of the memory device comprises: performing a folding operation on the individual higher-level cell block to cause data to be transferred from the individual higher-level cell block to the one or more lower-level cell blocks.

In Example 19, the subject matter of Examples 14-16 includes, wherein the causing of the data to be transferred from the individual higher-level cell block to the one or more lower-level cell blocks comprises: marking the individual higher-level cell block as a candidate for higher-level cell-to-lower-level cell block data transfer.

In Example 20, the subject matter of Example 17 includes, wherein the individual higher-level cell block is part of a set of marked higher-level cell blocks that are marked as candidates for higher-level cell-to-lower-level cell block data transfer, and wherein the operations comprise: performing a folding operation on the set of marked higher-level cell blocks, the folding operation causing data of each select higher-level cell block in the set of marked higher-level cell blocks to be transferred to a set of select lower-level cell blocks of the memory device.

In Example 21, the subject matter of Examples 14-18 includes, wherein the threshold value is a first threshold value, and wherein the operations comprise: in response to determining that the individual periodic read count is not greater than the first threshold value: determining whether the individual periodic read count is less than or equal to the first threshold value and the individual periodic read count is greater than a second threshold value; and in response to determining that the individual periodic read count is less than or equal to the first threshold value and that the individual periodic read count greater than a second threshold value: determining whether the individual higher-level cell block satisfies at least one trigger condition for transferring the individual higher-level cell block to the one or more lower-level cell blocks; and in response to determining that the individual higher-level cell block satisfies the at least one trigger condition, causing data to be transferred from the individual higher-level cell block to one or more lower-level cell blocks of the memory device.

Example 22 is a system to implement of any of any of Examples 16-21.

Example 23 is a method to implement of any of Examples 16-21.

Example 24 is a method comprising: accessing, by a processing device of a memory sub-system, an individual periodic read count of an individual higher-level cell block of a memory device of the memory sub-system, the individual periodic read count being reset to an initial value after a predetermined period of time; determining, by the processing device, that the individual periodic read count is greater than a threshold value; and in response to determining that the individual periodic read count is greater than the threshold value, causing, by the processing device, data to be transferred from the individual higher-level cell block to one or more lower-level cell blocks of the memory device.

Example 25 is at least one machine-readable medium including instructions that, when executed by a processing device of a memory sub-system, cause the processing device to perform operations to implement of Example 24.

Example 26 is a system to implement of Example 24.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (e.g., non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims.

The specification and drawings are, accordingly, to be regarded in an illustrative sense rather than a restrictive sense.

What is claimed is:

1. A system comprising:
a memory device; and
a processing device, operatively coupled to the memory device, configured to perform operations comprising:
monitoring a set of periodic read counts for a set of higher-level cell blocks of the memory device, each periodic read count of the set of periodic read counts being reset to an initial value after a predetermined period of time; and
for an individual higher-level cell block of the set of higher-level cell blocks:
accessing, from the set of periodic read counts, an individual periodic read count of the individual higher-level cell block;
determining whether the individual periodic read count is greater than a threshold value; and
in response to determining that the individual periodic read count is greater than the threshold value, causing data to be transferred from the individual higher-level cell block to one or more lower-level cell blocks of the memory device.

2. The system of claim 1, wherein the causing of the data to be transferred from the individual higher-level cell block to the one or more lower-level cell blocks of the memory device comprises:
performing a folding operation on the individual higher-level cell block to cause data to be transferred from the individual higher-level cell block to the one or more lower-level cell blocks.

3. The system of claim 1, wherein the causing of the data to be transferred from the individual higher-level cell block to the one or more lower-level cell blocks comprises:
marking the individual higher-level cell block as a candidate for higher-level cell-to-lower-level cell block data transfer.

4. The system of claim 3, wherein the individual higher-level cell block is part of a set of marked higher-level cell blocks that are marked as candidates for higher-level cell-to-lower-level cell block data transfer, and wherein the operations comprise:
performing a folding operation on the set of marked higher-level cell blocks, the folding operation causing data of each select higher-level cell block in the set of marked higher-level cell blocks to be transferred to a set of select lower-level cell blocks of the memory device.

5. The system of claim 1, wherein each higher-level cell block is a quad-level cell (QLC) block.

6. The system of claim 2, wherein each lower-level cell block is a triple-level cell (TLC) block.

7. The system of claim 1, wherein the threshold value is a first threshold value, and wherein the operations comprise:
in response to determining that the individual periodic read count is not greater than the first threshold value:
determining whether the individual periodic read count is less than or equal to the first threshold value and the individual periodic read count is greater than a second threshold value; and
in response to determining that the individual periodic read count is less than or equal to the first threshold value and that the individual periodic read count greater than a second threshold value:
determining whether the individual higher-level cell block satisfies at least one trigger condition for transferring the individual higher-level cell block to the one or more lower-level cell blocks; and
in response to determining that the individual higher-level cell block satisfies the at least one trigger condition, causing data to be transferred from the individual higher-level cell block to one or more lower-level cell blocks of the memory device.

8. The system of claim 7, wherein the at least one trigger condition relates to a raw error bit rate (RBER) of the individual higher-level cell block.

9. The system of claim 8, wherein the at least one trigger condition is satisfied when the RBER of the individual higher-level cell block is greater than a RBER threshold value.

10. The system of claim 1, wherein the causing of the data to be transferred from the individual higher-level cell block to one or more lower-level cell blocks of the memory device comprises:
releasing the individual higher-level cell block for reuse after data has been copied from the individual higher-level cell block to the one or more lower-level cell blocks.

11. The system of claim 1, wherein the operations comprise:
receiving, from a host system, a request to read a set of blocks of the memory device, the set of blocks including the individual higher-level cell block, the accessing of the individual periodic read count being performed in response to the request.

12. The system of claim 1, wherein the accessing of the individual periodic read count is performed periodically based on the predetermined period of time.

13. The system of claim 1, wherein the operations comprise:
determining available data storage capacity of the memory device; and
transferring data back from the one or more lower-level cell blocks to one or more higher-level cell blocks based on the available data storage capacity.

14. At least one non-transitory machine-readable storage medium comprising instructions that, when executed by a processing device of a memory sub-system, cause the processing device to perform operations comprising:
accessing an individual periodic read count of an individual higher-level cell block of a memory device of the memory sub-system, the individual periodic read count being reset to an initial value after a predetermined period of time;
determining whether the individual periodic read count is greater than a threshold value; and
in response to determining that the individual periodic read count is greater than the threshold value, causing data to be transferred from the individual higher-level cell block to one or more lower-level cell blocks of the memory device.

15. The at least one non-transitory machine-readable storage medium of claim 14, wherein the operations are performed periodically based on the predetermined period of time.

16. The at least one non-transitory machine-readable storage medium of claim 14, wherein the causing of the data to be transferred from the individual higher-level cell block to the one or more lower-level cell blocks of the memory device comprises:
performing a folding operation on the individual higher-level cell block to cause data to be transferred from the individual higher-level cell block to the one or more lower-level cell blocks.

17. The at least one non-transitory machine-readable storage medium of claim 14, wherein the causing of the data to be transferred from the individual higher-level cell block to the one or more lower-level cell blocks comprises:
marking the individual higher-level cell block as a candidate for higher-level cell-to-lower-level cell block data transfer.

18. The at least one non-transitory machine-readable storage medium of claim 17, wherein the individual higher-level cell block is part of a set of marked higher-level cell blocks that are marked as candidates for higher-level cell-to-lower-level cell block data transfer, and wherein the operations comprise:
performing a folding operation on the set of marked higher-level cell blocks, the folding operation causing data of each select higher-level cell block in the set of marked higher-level cell blocks to be transferred to a set of select lower-level cell blocks of the memory device.

19. The at least one non-transitory machine-readable storage medium of claim 14, wherein the threshold value is a first threshold value, and wherein the operations comprise:
in response to determining that the individual periodic read count is not greater than the first threshold value:
determining whether the individual periodic read count is less than or equal to the first threshold value and the individual periodic read count is greater than a second threshold value; and
in response to determining that the individual periodic read count is less than or equal to the first threshold value and that the individual periodic read count greater than a second threshold value:
determining whether the individual higher-level cell block satisfies at least one trigger condition for transferring the individual higher-level cell block to the one or more lower-level cell blocks; and
in response to determining that the individual higher-level cell block satisfies the at least one trigger condition, causing data to be transferred from the individual higher-level cell block to one or more lower-level cell blocks of the memory device.

20. A method comprising:
accessing, by a processing device of a memory sub-system, an individual periodic read count of an individual higher-level cell block of a memory device of the memory sub-system, the individual periodic read count being reset to an initial value after a predetermined period of time;
determining, by the processing device, that the individual periodic read count is greater than a threshold value; and
in response to determining that the individual periodic read count is greater than the threshold value, causing, by the processing device, data to be transferred from the individual higher-level cell block to one or more lower-level cell blocks of the memory device.
